(19) United States
(12) Patent Application Publication
(10) Pub. No.: US 2026/0104899 A1
(43) Pub. Date: Apr. 16, 2026

(54) DYNAMIC NETWORK WAKE UP METHOD AND SYSTEM FOR IMPLEMENTING

(71) Applicant: Rakuten Mobile, Inc., Tokyo (JP)

(72) Inventor: Vinay Kamleshkumar SINGH, Tokyo (JP)

(21) Appl. No.: 18/915,253

(22) Filed: Oct. 14, 2024

(51) Int. Cl. G06F 9/4401

(52) U.S. Cl. CPC G06F 9/4416

(57) ABSTRACT

A method includes collecting characteristic data for each node of a plurality of nodes in a mesh network, wherein each of the plurality of nodes is capable of communicating with all of the plurality of nodes. The method further includes performing pattern recognition on the collected characteristic data. The method further includes generating a wake-up strategy for each of the plurality of nodes based on the pattern recognition. The method further includes controlling each of the plurality of nodes based on the wake-up strategy. The method further includes collecting updated characteristic data for each node of the plurality of nodes during the controlling of the plurality of nodes based on the wake-up strategy. The method further includes performing updated pattern recognition using the updated characteristic data. The method further includes updating the wake-up strategy based on the updated pattern recognition.

### FIELD

The present disclosure relates to a dynamic network wake up method and a system for implementing the method.

### BACKGROUND

As connectivity between devices increases, the demand on power usage for connected devices increases. Along with the rapid development of Internet of Things (IoT) technology in recent years, the applications of smart home, smart building and smart factory increase increases connectivity between various devices. In some instances, the connections between these devices are implemented using a mesh network. A mesh network permits each node or communicate with other nodes within the network often through the use of data packets. One type of mesh network utilized in IoT technology is Bluetooth®. In Bluetooth mesh network technology, a low power node receives data through another node.

In order to conserve power, nodes within the mesh network spend a majority of time in a sleep, or low power mode, where data transmission is avoided. To facilitate communication between nodes in the mesh network, a wake-up signal is transmitted to the nodes within the network in order to cause the nodes to exchange data for implementing the functionality of the nodes or the network.

### SUMMARY

According to at least one embodiment, a method includes collecting characteristic data for each node of a plurality of nodes in a mesh network, wherein each of the plurality of nodes is capable of communicating with all of the plurality of nodes. The method further includes performing pattern recognition on the collected characteristic data. The method further includes generating a wake-up strategy for each of the plurality of nodes based on the pattern recognition. The method further includes controlling each of the plurality of nodes based on the wake-up strategy. The method further includes collecting updated characteristic data for each node of the plurality of nodes during the controlling of the plurality of nodes based on the wake-up strategy. The method further includes performing updated pattern recognition using the updated characteristic data. The method further includes updating the wake-up strategy based on the updated pattern recognition.

According to at least one embodiment a system configured to execute a process. The process includes collecting characteristic data for each node of a plurality of nodes in a mesh network, wherein each of the plurality of nodes is capable of communicating with all of the plurality of nodes. The process further includes performing pattern recognition on the collected characteristic data. The process further includes generating a wake-up strategy for each of the plurality of nodes based on the pattern recognition. The process further includes controlling each of the plurality of nodes based on the wake-up strategy. The process further includes collecting updated characteristic data for each node of the plurality of nodes during the controlling of the plurality of nodes based on the wake-up strategy. The process further includes performing updated pattern recognition using the updated characteristic data. The process further includes updating the wake-up strategy based on the updated pattern recognition.

According to at least one embodiment a non-transitory computer readable medium configured to cause a system to execute a method. The method includes collecting characteristic data for each node of a plurality of nodes in a mesh network, wherein each of the plurality of nodes is capable of communicating with all of the plurality of nodes. The method further includes performing pattern recognition on the collected characteristic data. The method further includes generating a wake-up strategy for each of the plurality of nodes based on the pattern recognition. The method further includes controlling each of the plurality of nodes based on the wake-up strategy. The method further includes collecting updated characteristic data for each node of the plurality of nodes during the controlling of the plurality of nodes based on the wake-up strategy. The method further includes performing updated pattern recognition using the updated characteristic data. The method further includes updating the wake-up strategy based on the updated pattern recognition.

### BRIEF DESCRIPTION OF THE DRAWINGS

Features, aspects, and advantages of embodiments of the disclosure will be described below with reference to the accompanying drawings, in which like reference numerals denote like elements, and wherein:

FIG. 1 is a diagram of a mesh network in accordance with to at least one embodiment.

FIG. 2 is a schematic flow chart of a system for implementing a wake up of a mesh network in accordance with at least one embodiment.

FIG. 3 is a flow chart of a method of dynamically waking up a mesh network in accordance with at least one embodiment.

FIG. 4 is a flow chart of a method of dynamically waking up a mesh network in accordance with at least one embodiment.

FIG. 5 is a block diagram of a system for dynamically waking up a mesh network in accordance with at least one embodiment.

FIG. 6 is a diagram of example components of a device for dynamically waking up a mesh network in accordance with at least one embodiment.

### DETAILED DESCRIPTION

The following detailed description of example embodiments refers to the accompanying drawings. The present disclosure provides illustrations and descriptions, but is not intended to be exhaustive or to limit the implementations to the precise form disclosed. Modifications and variations are possible in light of the present disclosure or may be acquired from practice of the implementations. Further, one or more features or components of one embodiment may be incorporated into or combined with another embodiment (or one or more features of another embodiment). Additionally, the flowchart and description of operations provided below relate to at least one of the embodiments in the present disclosure. It should be noted that it is possible to make other embodiments that do not exactly match the flowchart and its description. It is understood that in other embodiments one or more operations may be omitted, one or more operations may be added, one or more operations may be performed simultaneously (at least in part).

It will be apparent that systems and/or methods, described herein, may be implemented in different forms of hardware, software, or a combination of hardware and software. The actual specialized control hardware or software code used to implement these systems and/or methods should not limit their implementations. Thus, the operation and behavior of the systems and/or methods are described herein without reference to specific software code. It is understood that software and hardware may be designed to implement the systems and/or methods based on the description herein.

Even though particular combinations of features are recited in the claims and/or disclosed in the specification, the particular combinations are not intended to limit the disclosure of implementations. In fact, many of these features may be combined in ways not specifically recited in the claims and/or disclosed in the specification. Even if a dependent claim directly depends on only one claim, the present disclosure may indicate that the dependent claim is dependent on other claims in the claim set.

No element, act, or instruction used herein should be construed as critical or essential unless explicitly described as such. Also, as used herein, the articles “a” and “an” (in other words, nouns not mentioned in the plural) are intended to include one or more items, and may be used interchangeably with “one or more.” Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B],” “[A] and/or [B],” or “at least one of [A] or [B]” are to be understood as including only A, only B, or both A and B.

As more smart components are deployed for the convenience of users, there is a consistent struggle between connectivity and power consumption. Users expect devices to connect quickly and provide desired functionality rapidly. While users simultaneously seek to minimize power consumption, especially for battery powered devices. Mesh networks have been developed as a strategy for improving connectivity for devices. Communication standards, such as Bluetooth ®, are used to allow devices to wirelessly communicate throughout the mesh network. For the devices to communicate with one another, the devices, also called nodes, in the network are awake, i.e., in a high-power consumption mode. During a time period that the devices are not communicating with each other, the devices go into a sleep mode, i.e., a low-power consumption mode. The use of the sleep mode and awake mode helps to reduce power consumption of the devices in the mesh network.

In order to wake up devices within the mesh network, some approaches use a static wake-up protocol that wakes all of the devices in the mesh network. The static approach is not easily modified to account for performance of devices in the mesh network or specific functionality sought by the user of the network. Further, waking all devices within the mesh network unnecessarily increases power consumption by placed devices with functionality that is not sought by the user in the high-power consumption mode. These static wake-up protocols target an increase in connectivity at the expense of power consumption.

At least one embodiment of the current disclosure utilizes a dynamic wake-up method to maintain high levels of connectivity while reducing power consumption of the mesh network. The dynamic wake-up method is able to use machine learning (ML) to recognize patterns in the usage of devices, or nodes, in the mesh network to determine times and durations of usage of the devices. The dynamic wake-up method is also able to selectively activate less than all of the devices within the mesh network, so that devices with functionality not currently being sought are able to remain in the sleep mode to reduce overall power consumption. In some embodiments, the dynamic wake-up method is also able to recognize similarities in the patterns of usage of different devices. This allows the grouping, or clustering, of these devices to be awakened as a unit. The clustering of the devices reduces processing load for determining and implementing a wake-up strategy for the mesh network. In some embodiments, the wake-up method also identified anomalies within the functioning of one or more devices within the mesh network. For example, in some instances, a device is determined to function poorly if the device remains awake longer than an identified period of time. In such a situation, the wake-up method is able to assign a companion, or friend, device to help implement the functionality of the anomalous device during periods where the device is placed in the sleep, low-power mode, in order to maintain the desired functionality of the mesh network.

The dynamic wake-up method also collects data during operation of the mesh network operating using the dynamic wake-up method in order to update the dynamic wake-up method. Characteristic data, such as timing and duration of device activation, are collected and feedback in ML algorithms to continue to refine the wake-up strategy and to account for evolving usage of the network. By continuing to feedback characteristic data about the operation of the mesh network the dynamic wake-up method is continually updated in order to improve power consumption of the mesh network while still providing connectivity to meet the demands of the user.

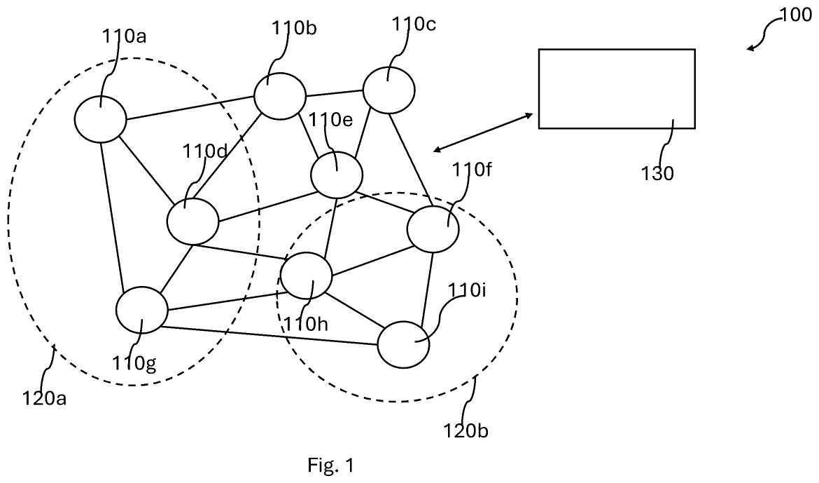

FIG. 1 is a diagram of a mesh network 100 in accordance with to at least one embodiment. The mesh network 100 includes a plurality of nodes 110a-110i, collectively referred to as nodes 110. Each of the nodes 110 corresponds to a device or component within the mesh network 100 that is capable of sending or receiving data. The mesh network 100 further includes a first cluster 120a of nodes; and a second cluster 120b of nodes. The first cluster 120a of nodes includes nodes 1110a, 110d and 110g. The second cluster 120b of nodes includes nodes 110f, 110h and 110i. The mesh network 100 further includes a central controller 130 configured to communicate with the nodes 110. In some embodiments, the central controller 130 is a server or other device having processing ability that is external to the nodes 110. In some embodiments, the central controller 130 is a command node among the nodes 110. In some embodiments, the central controller 130 is a combination of devices, such as multiple nodes 110 within the mesh network 100 or a cloud-based processing unit.

The nodes 110 are devices that are capable of communicating with one another as well as with the central controller 130. In some embodiments, the nodes 110 communicate with each other using wireless technology, such as Bluetooth®. In some embodiments, the nodes 110 communicate with each other using Bluetooth Mesh Profile Specification v1.0.1, or other similar Bluetooth communication protocols. The mesh network 100 includes security features such as encryption or authentication for accessing the nodes 110. In some embodiments, the mesh network 100 is protected by Bluetooth LE Secure Connections. In some embodiments, the mesh network 100 utilizes security key rotations for authenticating access to the nodes 110 within the mesh network 100. In some embodiments, the security key rotation is implemented using Diffie-Hellman key exchange.

The first cluster 120a includes nodes that have similar characteristics. These characteristics include performance parameters such a timing of activation, frequency of activation, or duration of activation. In some embodiments, characteristics are considered similar in a situation where the measured characteristics for each of the nodes within the first cluster 120a differ from the measured characteristics of every other node within the first cluster 120a by less than 10%. These similar characteristics indicate that the node 110a, node 110d and node 110g are all active during a similar time frame for a similar duration. Due to the similar characteristics of the nodes in the first cluster 120a, the central controller 130 is able to wake-up the node 110a, node 110d, and node 110g as a group instead of as individual nodes. Waking up the nodes 110a, 110d and 110g as a group reduces processing load on the control controller 130 relative to other approaches and does not significantly increase power consumption because the nodes within the first cluster 120a are not active for noticeably longer durations or more frequently than would occur in a situation where the nodes 110a, 110d and 110g are controlled individually.

Similar to the first cluster 120a, the second cluster 120b includes nodes 110f, 110h, and 110i, which have similar characteristics. These similar characteristics allow the central controller 130 to wake up the nodes 110f, 110h, and 110i as a group. As noted above, the ability to wake-up nodes in a group reduces processing load without significantly increasing power consumption in comparison with other approaches.

The node 110b, node 110c and node 110e are not part of a cluster. These nodes have characteristics that are sufficiently dissimilar to the other nodes 110 within the mesh network 100 that controlling any of node 110b, node 110c or node 110e as part of a cluster with another node would significantly increase the power consumption with respect to at least one node or reduce connectivity amongst the nodes 110 of the mesh network. Therefore, the increase in processing load on the central controller 130 for controlling the nodes 110b, 110c and 110e individually is acceptable.

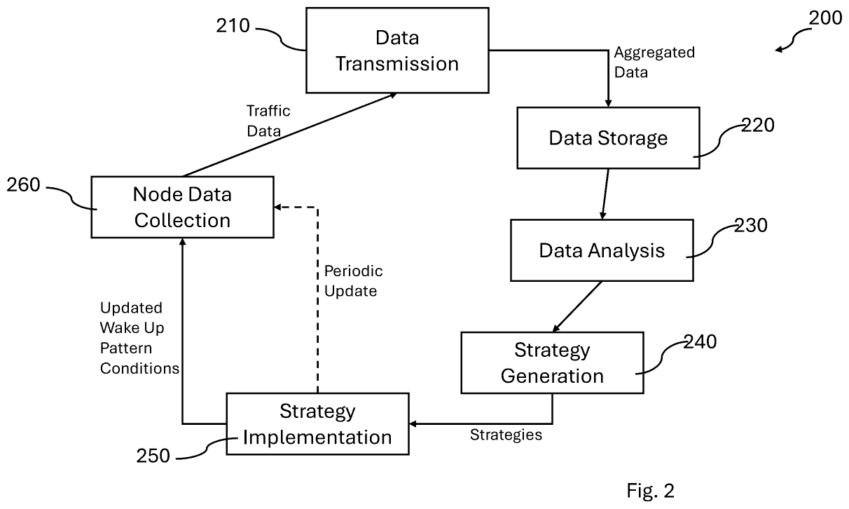

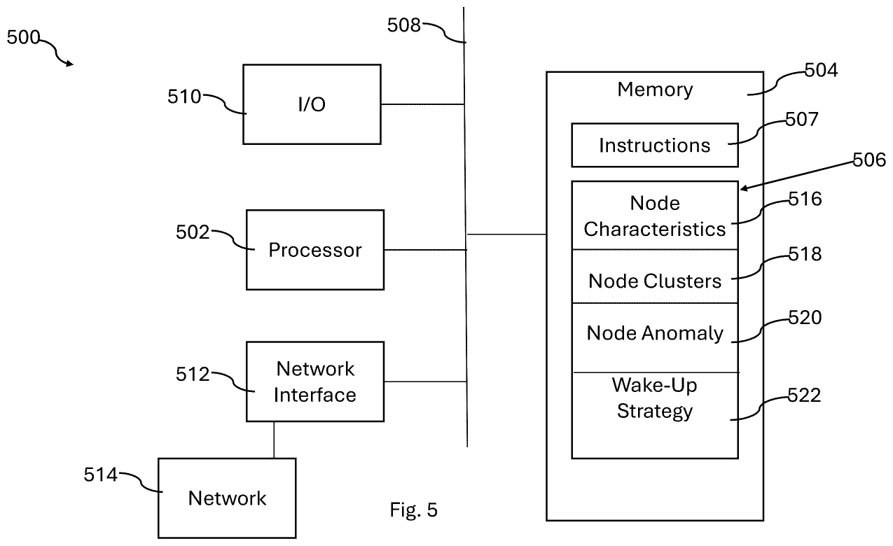

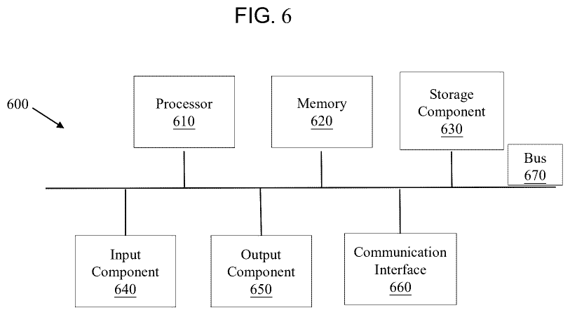

FIG. 2 is a schematic flow chart of a system 200 for implementing a wake up of a mesh network in accordance with at least one embodiment. In some embodiments, the system 200 is implemented using the central controller 130 (FIG. 1). In some embodiments, the system 200 is implemented using the system 500 (FIG. 5), the system 600 (FIG. 6), or another suitable system.

The system 200 includes circuitry for controlling data transmission 210 amongst nodes of a mesh network, such as mesh network 100 (FIG. 1). In some embodiments, the data transmission is implemented using customized generic attribute (GATT) services. The customized GATT services control waking up of nodes within the mesh network based on a dynamic wake up strategy. The customized GATT services are updated based on performance of the mesh network. In some embodiments, machine learning (ML) is utilized for pattern recognition during operation of the mesh network in order to identify clusters, anomalies or other features of the mesh network. These patterns are utilized to determine a wake-up strategy. The customized GATT services all collection of characteristics of nodes within the mesh network for the pattern recognition.

The system 200 further includes circuitry for implementing data storage 220 of characteristics of nodes of the mesh network collected during the data transmission 210. In some embodiments, the data storage 220 is implemented using a non-transitory memory. In some embodiments, the data storage 220 is implemented using a central server. In some embodiments, the data storage 220 is implemented using a cloud-based storage.

The system 200 further includes circuitry for implementing data analysis 230 of the characteristics of the nodes of the mesh network stored in the data storage 220. The data analysis 230 performs pattern recognition on the nodes to determine timing and durations of activity of the nodes within the mesh network in order to identify clusters, anomalies or other features of the nodes in the mesh network. In some embodiments, the data analysis 230 uses time forecasting, such as auto-regressive integrated moving average (ARIMA) to model or predict short-term traffic patterns for each node in the mesh network. A traffic pattern indicates whether the node was sending or receiving data and for how long. In some embodiments, the data analysis 230 performs clustering using a K-means clustering algorithm to identify groups of nodes with similar traffic patterns. In some embodiments, a target number of cluster is determined using the elbow method. The elbow method is a heuristic analysis where a number of explained variations within a system are plotted versus a number of clusters in the system; and an inflection point of the plot is selected. By determining a target number of clusters within the mesh network, the data analysis 230 is able to improve efficiency in cluster determination by stopping the clustering analysis in response to identifying a number of clusters equal to the target number of clusters. In addition, continuing the clustering analysis until the target number of clusters is identified helps to reduce processing load on the system 200 during operation of the mesh network by waking up clusters of nodes in unison. As discussed above, waking clusters of nodes as a group helps to reduce processing load without significantly increasing power consumption. This in turn leads to improved operation of the mesh network. In some embodiments, the data analysis 230 performs anomaly detection using an Isolation Forest algorithm to detect unusual traffic patterns within the mesh network. Once the nodes associated with the unusual traffic patterns are identified, remedial efforts are used to minimize negative impacts to the mesh network. For example, in a situation where a node ceases to function properly after being active for a defined period of time, the data analysis 230 will recognize an anomaly at that node. The system 200 is then able to assign a related or “friend” node to assist in performing the functionality of the anomalous node so that the mesh network, as a whole, continues to function as designed.

In some embodiments, the data analysis 230 includes identifying network topology. Network topology helps to identify nodes within the mesh network that depend on other nodes to fully implement the desired functionality. The network topology also helps to identify nodes within the mesh network that control access to other nodes within the mesh network. In some embodiments, the data analysis 230 constructs a graphical representation of the nodes within the mesh network. In some embodiments, the data analysis 230 implements a Betweenness Centrality algorithm to identify nodes used for message relay. This helps to ensure that the nodes used for message relay wake-up with sufficient time to relay messages to other nodes to maintain the functionality of the mesh network. For example, in a situation where a relay node controls message relay to a first node, if the relay node is asleep when the message directed to the first node is sent from a second node, there is an increased risk that the first node will not receive the message. Therefore, waking the relay node at a time sufficient to permit proper propagation of the message from the second node to the first node helps to ensure that the mesh network functions as designed.

The system 200 further includes circuity for strategy generation 240 for developing a dynamic wake up strategy for the mesh network. The strategy generation 240 uses the pattern recognition of the data analysis 230 to develop a strategy for waking up each of the nodes within the mesh network. In some embodiments, the wake-up strategy includes adaptive duty cycling based on historical data. In some embodiments, the wake-up strategy includes event driven wake-ups triggered by detected activity within the mesh network. For example, in response to detecting that a first node is attempting to transmit a message, a relay node receives a wake-up signal in order to facility propagation of the message from the first node to a destination within the mesh network. In some embodiments, the wake-up strategy coordinates waking up of nodes based on clustering of the nodes. In some embodiments, the wake-up strategies are based on network topology, detected battery level, or message priority. For example, if a node has a detected battery level below a predetermined threshold, the node is woken less often in order to conserve power at the node. In some embodiments, a combination of factors is utilized in generating the wake-up strategy. For example, in some embodiments, a node having a battery level below a predetermined threshold value is woken in response to the node being a target of a message having a priority of at least a predetermined priority level.

In some embodiments, the strategy generation 240 utilizes at least one of the following strategies: chromosome, fitness function, mutation, or crossover. The chromosome strategy wakes up a node based on an expected functionality request for the mesh network. The fitness function strategy balances power savings with network responsiveness. The mutation strategy introduces small changes in wake-up timing to determine impacts to power consumption and network responsiveness. The crossover strategy combines wake up schedules for two different target solutions. For example, in some embodiments, the crossover strategy utilizes Multi-objective Optimization (NSGA-II) to balance network performance with battery life of the nodes.

The wake-up strategy generated by the strategy generation 240 is considered dynamic because the system 200 continues to update data associated with node performance and adjust the strategy as node performance or demand on a node changes.

The system 200 further includes circuitry for strategy implementation 250 for executing the dynamic wake up strategy in the mesh network. The strategy implementation 250 wakes up the nodes within the mesh network according to the dynamic wake-up strategy generated by the strategy generation 240. The strategy implementation 250 uses the customized GATT services based on the dynamic wake-up strategy to implement the functionality of the mesh network. In some embodiments, some nodes are woken individually, while other nodes are woken as part of clusters. During operation of the mesh network, node performance is monitored. In some embodiments, the strategy implementation 250 uses a “friend” node feature. In some embodiments, a window size for the mesh network is determined based on the dynamic wake-up strategy. The window size indicates a size (number of bits) of packets used in the mesh network as well as how often the packets are transmitted through the mesh network.

The strategy implementation 250 is performed for a predetermined number of iterations of a scanning interval. A scanning interval is a period of time over which data is collected for nodes within the mesh network. The scanning interval is determined in order to obtain a sufficient amount of data on node performance while not obtaining needlessly repetitive data. In some embodiments, the scanning interval ranges from about 15 minutes to about 1 hour. In some embodiments, a duration of the scanning interval depends on an activity level of the mesh network. For example, during a period of low activity, such as nighttime, the scanning interval is longer, e.g., 1 hour; while during a high activity period, such as midday, the scanning interval is shorter, e.g., 15 minutes. If the scanning interval is too long then the wake-up strategies are not updated with sufficient frequency to conserve power and maintain targeted mesh network performance. If the scanning interval is too short then future iterations of the wake-up strategies have a higher risk of being impacted by anomalous behavior in the mesh network leading to inefficient operation of the mesh network. The number of iterations of the scanning interval helps to ensure that sufficient amounts of data are collected for updating wake-up strategies without unduly delaying updating of the wake-up strategies. In some embodiments, the number of iterations ranges from 3 to 5.

The system 200 further includes circuitry for node data collection 260. The node data collection 260 receives a plurality of types of information from the strategy implementation 250. The node data collection 260 collects periodic updates of node performance after the predetermined number of iterations of a scanning interval. This type of data collection is a result of the mesh network operating under normal conditions. The node data collection 260 also collects node performance data due to updated wake-up pattern conditions. The updated wake-up pattern conditions indicate a significant change in the performance of nodes within the mesh network. In some embodiments, a significant change involves additional or removal of a node from the mesh network. In some embodiments, a significant change involves updating a software for one or more nodes within the mesh network. In some embodiments, a significant change involves a change in network topology of the mesh network.

The traffic data for the performance of the nodes in the mesh network is then transferred to the circuitry for data transmission 210. The system 200 continues to analyze performance of the mesh network and update wake-up strategies for helping to ensure proper functionality of the mesh network while reducing power consumption of the mesh network.

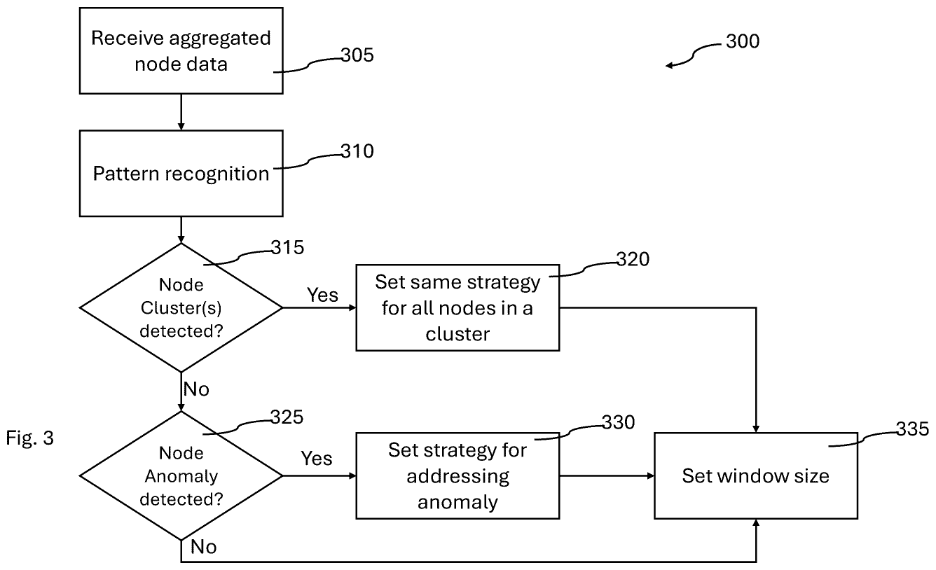

FIG. 3 is a flow chart of a method 300 of dynamically waking up a mesh network in accordance with at least one embodiment. In some embodiments, the method 300 is at least partially implemented using the system 200 (FIG. 2). In some embodiments, the method 300 is at least partially implemented using the system 500 (FIG. 5), the system 600 (FIG. 6), or another suitable system. The method 300 helps to develop a dynamic wake-up strategy for a mesh network.

In operation 305, aggregated node data is received. The aggregated node data indicates performance data for each of the nodes within the mesh network. In some embodiments, characteristics of the nodes captured by the aggregated node data includes timing of activation, frequency of activation or periods of transmission of data by the corresponding node. In some embodiments, the aggregated node data is collected during operation of the mesh network using customized GATT services.

In operation 310, the aggregated node data is subjected to pattern recognition. The pattern recognition helps to determine trends within the performance of each node within the mesh network. The pattern recognition on the nodes determines timing and durations of activity of the nodes within the mesh network in order to identify clusters, anomalies or other features of the nodes in the mesh network. In some embodiments, the pattern recognition uses time forecasting, such ARIMA to model or predict short-term traffic patterns for each node in the mesh network. In some embodiments, the pattern recognition performs clustering using a K-means clustering algorithm to identify groups of nodes with similar traffic patterns. In some embodiments, a target number of cluster is determined using the elbow method. By determining a target number of clusters within the mesh network, the pattern recognition helps to improve efficiency in cluster determination. Waking clusters of nodes as a group helps to reduce processing load without significantly increasing power consumption, which improves operation of the mesh network. In some embodiments, the pattern recognition performs anomaly detection using an Isolation Forest algorithm to detect unusual traffic patterns within the mesh network.

In some embodiments, the pattern recognition includes identifying network topology. Network topology helps to identify nodes within the mesh network that depend on other nodes to fully implement the desired functionality, which helps to identify clusters within the mesh network. In some embodiments, the pattern recognition implements a Betweenness Centrality algorithm to identify network topology.

In operation 315, a determination is made regarding whether any node clusters are detected based on the pattern recognition. In response to detection of at least one node cluster, the method 300 proceeds to operation 320. In response to failure to detect any node clusters, the method 300 proceeds to operation 325.

In operation 320, a same wake-up strategy is assigned to all nodes within an identified node cluster. In some embodiments, the wake-up strategy is determined using the circuitry for strategy generation 240 in the system 200 (FIG. 2). In some embodiments, the wake-up strategy is determined using a process other than that described with respect to the strategy generation 240 of the system 200 (FIG. 2).

In operation 325, a determination is made regarding whether any node anomalies are detected based on the pattern recognition. In response to detection of at least one node anomaly, the method 300 proceeds to operation 330. In response to failure to detect any node anomalies, the method 300 proceeds to operation 335.

In operation 330, a strategy for addressing the determined node anomalies is set. In some embodiments, strategies for addressing node anomalies include designating a “friend” node to assist in the implementation of the functionality of the anomalous node. In some embodiments, strategies for addressing node anomalies include determining a sequence of waking up of nodes in the mesh network. In some embodiments, strategies for addressing node anomalies include minimizing a period of activation of a node within the mesh network.

In operation 335, a window size for messages in the mesh network is set. The window size indicates a size (number of bits) of packets used in the mesh network as well as how often the packets are transmitted through the mesh network. In some embodiments, the window size is set based on detected node anomalies. In some embodiments, the window size is set for facilitate operation of the mesh network to achieve the designed functionality. In some embodiments, different window sizes are used for different times of day based on expected traffic on the mesh network determined based on the pattern recognition.

The method 300 helps to generate dynamic wake-up strategies for use in a mesh network through the use of pattern recognition. The dynamic wake-up strategies help to reduce power consumption of the nodes in the mesh network while still maintaining designed functionality of the mesh network.

In some embodiments, the method 300 includes at least one additional operation. For example, in some embodiments, the method 300 further includes detecting changes to the mesh network, such as addition or removal of a node from the mesh network. In some embodiments, at least one operation of the method 300 is removed. For example, in some embodiments, the operation 335 is omitted and a window size is maintained. In some embodiments, an order of operations of the method 300 is adjusted. For example, in some embodiments, the operation 335 occurs prior to the operation 315. Other modifications to the method 300 would be understood by those skilled in the art.

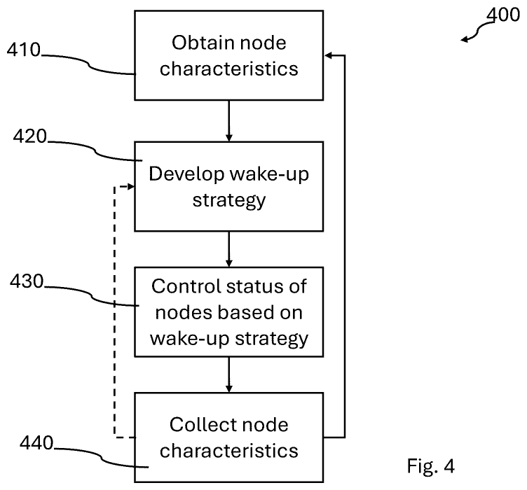

FIG. 4 is a flow chart of a method 400 of dynamically waking up a mesh network in accordance with at least one embodiment. In some embodiments, the method 400 is at least partially implemented using the system 200 (FIG. 2). In some embodiments, the method 400 is at least partially implemented using the system 500 (FIG. 5), the system 600 (FIG. 6), or another suitable system. The method 400 helps to operate a mesh network using a dynamic wake-up strategy.

In operation 410, node characteristics are obtained. The node characteristics indicate performance data for each of the nodes within the mesh network. In some embodiments, characteristics of the nodes captured include timing of activation, frequency of activation or periods of transmission of data by the corresponding node. In some embodiments, the aggregated node data is collected during operation of the mesh network using customized GATT services.

In operation 420, a wake-up strategy is developed. The wake-up strategy is developed based on pattern recognition through machine learning.

In some embodiments, the pattern recognition uses time forecasting, such as (ARIMA) to model or predict short-term traffic patterns for each node in the mesh network. In some embodiments, the wake-up strategy is developed using clustering using a K-means clustering algorithm to identify groups of nodes with similar traffic patterns. In some embodiments, a target number of cluster is determined using the elbow method. By determining a target number of clusters within the mesh network, the development of a wake-up strategy is able to improve efficiency in cluster determination by stopping the clustering analysis in response to identifying a number of clusters equal to the target number of clusters. In addition, continuing the clustering analysis until the target number of clusters is identified helps to reduce processing load during operation of the mesh network by waking up clusters of nodes in unison.

In some embodiments, the development of the wake-up strategy is performed using anomaly detection, e.g., using an Isolation Forest algorithm to detect unusual traffic patterns within the mesh network. Once the nodes associated with the unusual traffic patterns are identified, remedial efforts, such as assigning a “friend” node, are used to minimize negative impacts to the mesh network.

In some embodiments, developing the wake-up strategy includes identifying network topology. In some embodiments, a graphical representation of the nodes within the mesh network is constructed. In some embodiments, the network topology is identified using a Betweenness Centrality algorithm to identify nodes used for message relay. This helps to ensure that the nodes used for message relay wake-up with sufficient time to relay messages to other nodes to maintain the functionality of the mesh network.

In some embodiments, developing the wake-up strategy includes adaptive duty cycling based on historical data. In some embodiments, developing the wake-up strategy includes event driven wake-ups triggered by detected activity within the mesh network. In some embodiments, the wake-up strategy coordinates waking up of nodes based on clustering of the nodes. In some embodiments, the wake-up strategies are based on network topology, detected battery level, or message priority. In some embodiments, a combination of factors is utilized in generating the wake-up strategy. In some embodiments, the developing the wake-up strategy utilizes at least one of the following strategies: chromosome, fitness function, mutation, or crossover.

In operation 430, the nodes in the mesh network are controlled based on the wake-up strategy. The nodes are controlled so that the nodes are woken according to the wake-up strategy to implement the designed functionality of the mesh network.

In operation 440, node characteristics are collected during the operation of the mesh network in operation 430. This collection of node characteristic data is then fed back into the method 400 for updating of the wake-up strategy so that performance and power consumption of the mesh network continue to improve through each iteration of the method 400. In some embodiments, in response to normal operation of the mesh network, the collected node characteristics are fed back into operation 410, as indicated by the solid line in FIG. 4. In some embodiments, in response to detection of a significant change in the mesh network, e.g., addition or removal of a node, the collected node characteristics are fed back into operation 420, as indicated by the dashed line in FIG. 4.

The method 400 helps to operate a mesh network using dynamic wake-up strategies to help to reduce power consumption of the nodes in the mesh network while still maintaining designed functionality of the mesh network.

In some embodiments, the method 400 includes at least one additional operation. For example, in some embodiments, the method 400 further includes detecting changes to the mesh network, such as addition or removal of a node from the mesh network. In some embodiments, at least one operation of the method 400 is removed. For example, in some embodiments, the operation 440 is combined with the operation 410. In some embodiments, an order of operations of the method 400 is adjusted. For example, in some embodiments, the operation 430 occurs prior to the operation 410 in a first iteration of the method 400. Other modifications to the method 400 would be understood by those skill in the art.

FIG. 5 is a block diagram of a system 500 for dynamically waking up a mesh network in accordance with at least one embodiment. In some embodiments, the system 500 is usable to implement the method 300 (FIG. 3), the method 400 (FIG. 4) or another suitable method for dynamically waking up a mesh network according to a dynamic wake-up strategy.

System 500 includes a hardware processor 502 and a non-transitory, computer readable storage medium 504 encoded with, i.e., storing, the computer program code 506, i.e., a set of executable instructions. Computer readable storage medium 504 is also encoded with instructions 507 for interfacing with external devices. The processor 502 is electrically coupled to the computer readable storage medium 504 via a bus 508. The processor 502 is also electrically coupled to an I/O interface 510 by bus 508. A network interface 512 is also electrically connected to the processor 502 via bus 508. Network interface 512 is connected to a network 514, so that processor 502 and computer readable storage medium 504 are capable of connecting to external elements via network 514. The processor 502 is configured to execute the computer program code 506 encoded in the computer readable storage medium 504 in order to cause system 500 to be usable for performing a portion or all of the operations as described in the method 300 (FIG. 3), the method 400 (FIG. 4), the system 200 (FIG. 2), or the mesh network 100 (FIG. 1).

In some embodiments, the processor 502 is a central processing unit (CPU), a multi-processor, a distributed processing system, an application specific integrated circuit (ASIC), and/or a suitable processing unit.

In some embodiments, the computer readable storage medium 504 is an electronic, magnetic, optical, electromagnetic, infrared, and/or a semiconductor system (or apparatus or device). For example, the computer readable storage medium 504 includes a semiconductor or solid-state memory, a magnetic tape, a removable computer diskette, a random-access memory (RAM), a read-only memory (ROM), a rigid magnetic disk, and/or an optical disk. In some embodiments using optical disks, the computer readable storage medium 504 includes a compact disk-read only memory (CD-ROM), a compact disk-read/write (CD-R/W), and/or a digital video disc (DVD). In some embodiments, the computer readable storage medium 504 is part of a cloud storage system.

In some embodiments, the storage medium 504 stores the computer program code 506 configured to cause system 500 to perform a portion or all of the operations as described in the method 300 (FIG. 3), the method 400 (FIG. 4), the system 200 (FIG. 2), or the mesh network 100 (FIG. 1). In some embodiments, the storage medium 504 also stores information used for performing a portion or all of the operations as described in the method 300 (FIG. 3), the method 400 (FIG. 4), the system 200 (FIG. 2), or the mesh network 100 (FIG. 1) as well as information generated during performing a portion or all of the operations as described in the method 300 (FIG. 3), the method 400 (FIG. 4), the system 200 (FIG. 2), or the mesh network 100 (FIG. 1), such as a node characteristics parameter 516, a node clusters parameter 518, a node anomaly parameter 520, a wake-up strategy parameter 522 and/or a set of executable instructions to perform the operation of a portion or all of the operations as described in the method 300 (FIG. 3), the method 400 (FIG. 4), the system 200 (FIG. 2), or the mesh network 100 (FIG. 1).

In some embodiments, the storage medium 504 stores instructions 507 for interfacing with external devices. The instructions 507 enable processor 502 to generate images for display to the users of the system 500.

System 500 includes I/O interface 510. I/O interface 510 is coupled to external circuitry. In some embodiments, I/O interface 510 includes a keyboard, keypad, mouse, trackball, trackpad, touchscreen and/or cursor direction keys for communicating information and commands to processor 502.

System 500 also includes network interface 512 coupled to the processor 502. Network interface 512 allows system 500 to communicate with network 514, to which one or more other computer systems are connected. Network interface 512 includes wireless network interfaces such as BLUETOOTH, WIFI, WIMAX, GPRS, or WCDMA; or wired network interface such as ETHERNET, USB, or IEEE-1394. In some embodiments, method 100 or the processes described with respect to FIGS. 2-4B is implemented in two or more systems 500, and information is exchanged between different systems 500 via network 514.

FIG. 6 illustrates an embodiment of a device 600 for implementing a dynamic wake-up method in accordance with at least one embodiment. As shown in FIG. 6, the device 600 includes processor 610, a memory 620, a storage component 630, an input component 640, an output component 650, a communication interface 660, and a bus 670.

The processor 610, as used herein, means any type of computational circuit that may comprise hardware elements and software elements. The processor 610 may be embodied as a multi-core processor, a single core processor, or a combination of one or more multi-core processors and/or one or more single core processors, a distributed processing system, or the like. The processor 610 may be a Central Processing Unit (CPU), a graphics processing unit (GPU), an accelerated processing unit (APU), an application-specific integrated circuit (ASIC), or another type of processing component.

Memory 620 includes a non-transitory computer readable medium. Memory 620 includes a random-access memory (RAM), a read only memory (ROM), and/or another type of dynamic or static storage device (e.g., a flash memory, a magnetic memory, and/or an optical memory) that stores information and/or instructions for use by processor 610. The memory 620 comprises machine-readable instructions which are executable by the processor 610. These machine-readable instructions when executed by the processor 610 cause the processor 610 to perform one or more method steps of an embodiment described above.

Storage component 630 stores information and/or software related to the operation and use of the device 600. For example, storage component 630 may include a hard disk (e.g., a magnetic disk, an optical disk, a magneto-optic disk, and/or a solid-state disk), a compact disc (CD), a digital versatile disc (DVD), a floppy disk, a cartridge, a magnetic tape, and/or another type of non-transitory computer-readable medium, along with a corresponding drive.

Input component 640 is configured to receive information, such as user input. For example, the input component 640 may include, but not be limited to, a touch screen display, a keyboard, a keypad, a mouse, a button, a switch, and/or a microphone. Additionally, or alternatively, the input component 640 may include a sensor for sensing information (e.g., a global positioning system (GPS), an accelerometer, a gyroscope, and/or an actuator).

Output component 650 is configured to provide output information from the device 600. For example, the output component 650 may be, but not limited to, a display, a speaker, an instruction device to an external device, and/or one or more light-emitting diodes (LEDs).

Communication interface 660 is an interface that provides a communication connection to other devices, such as external devices and internal devices. The connection by the communication interface 660 can be a wired connection, a wireless connection, or a combination of wired and wireless connections, and can be a direct connection or an indirect connection via a communication network that exists between the device 600 and other devices. In other words, the standard of the communication interface 660 is not limited.

The bus 670 acts as an interconnect between the processor 610, the memory 620, the storage component 630, the input component 640, the output component 650, and the communication interface 660 of the device 600. The bus 670 may include a wired interconnection or a wireless interconnection.

The number and arrangement of components shown in FIG. 6 are provided as an example. In practice, device 600 may include additional components, fewer components, different components, or differently arranged components than those shown in FIG. 6. Additionally, or alternatively, a set of components (e.g., one or more components) of device 600 may perform one or more functions described as being performed by another set of components of device 600. Further, one or more method steps described in any of the embodiments may be performed utilizing a plurality of devices 600 in communication with one another.

An aspect of this description includes a method. The method includes collecting characteristic data for each node of a plurality of nodes in a mesh network, wherein each of the plurality of nodes is capable of communicating with all of the plurality of nodes. The method further includes performing pattern recognition on the collected characteristic data. The method further includes generating a wake-up strategy for each of the plurality of nodes based on the pattern recognition. The method further includes controlling each of the plurality of nodes based on the wake-up strategy. The method further includes collecting updated characteristic data for each node of the plurality of nodes during the controlling of the plurality of nodes based on the wake-up strategy. The method further includes performing updated pattern recognition using the updated characteristic data. The method further includes updating the wake-up strategy based on the updated pattern recognition. In some embodiments, performing pattern recognition includes identifying a cluster of nodes among the plurality of nodes, wherein each node in the cluster of nodes has similar characteristic data. In some embodiments, controlling each of the plurality of nodes includes controlling each of the plurality of nodes in the cluster of nodes in unison. In some embodiments, controlling each of the plurality of nodes includes controlling at least one node of the plurality of nodes other than the cluster of nodes independent from the cluster of nodes. In some embodiments, performing pattern recognition includes identifying an anomalous node in the plurality of nodes. In some embodiments, the method further includes assigning a friend node in the plurality of nodes to assist the anomalous node in implementing a functionality of the anomalous node. In some embodiments, generating the wake-up strategy includes generating the wake-up strategy having different wake-up protocols depending on a time of day.

An aspect of this description relates to a system configured to execute a process. The process includes collecting characteristic data for each node of a plurality of nodes in a mesh network, wherein each of the plurality of nodes is capable of communicating with all of the plurality of nodes. The process further includes performing pattern recognition on the collected characteristic data. The process further includes generating a wake-up strategy for each of the plurality of nodes based on the pattern recognition. The process further includes controlling each of the plurality of nodes based on the wake-up strategy. The process further includes collecting updated characteristic data for each node of the plurality of nodes during the controlling of the plurality of nodes based on the wake-up strategy. The process further includes performing updated pattern recognition using the updated characteristic data. The process further includes updating the wake-up strategy based on the updated pattern recognition. In some embodiments, performing pattern recognition includes identifying a cluster of nodes among the plurality of nodes, wherein each node in the cluster of nodes has similar characteristic data. In some embodiments, controlling each of the plurality of nodes includes controlling each of the plurality of nodes in the cluster of nodes in unison. In some embodiments, controlling each of the plurality of nodes includes controlling at least one node of the plurality of nodes other than the cluster of nodes independent from the cluster of nodes. In some embodiments, performing pattern recognition includes identifying an anomalous node in the plurality of nodes. In some embodiments, the process further includes assigning a friend node in the plurality of nodes to assist the anomalous node in implementing a functionality of the anomalous node. In some embodiments, generating the wake-up strategy includes generating the wake-up strategy having different wake-up protocols depending on a time of day.

An aspect of this description relates to a non-transitory computer readable medium configured to cause a system to execute a method. The method includes collecting characteristic data for each node of a plurality of nodes in a mesh network, wherein each of the plurality of nodes is capable of communicating with all of the plurality of nodes. The method further includes performing pattern recognition on the collected characteristic data. The method further includes generating a wake-up strategy for each of the plurality of nodes based on the pattern recognition. The method further includes controlling each of the plurality of nodes based on the wake-up strategy. The method further includes collecting updated characteristic data for each node of the plurality of nodes during the controlling of the plurality of nodes based on the wake-up strategy. The method further includes performing updated pattern recognition using the updated characteristic data. The method further includes updating the wake-up strategy based on the updated pattern recognition. In some embodiments, performing pattern recognition includes identifying a cluster of nodes among the plurality of nodes, wherein each node in the cluster of nodes has similar characteristic data. In some embodiments, controlling each of the plurality of nodes includes controlling each of the plurality of nodes in the cluster of nodes in unison. In some embodiments, controlling each of the plurality of nodes includes controlling at least one node of the plurality of nodes other than the cluster of nodes independent from the cluster of nodes. In some embodiments, performing pattern recognition includes identifying an anomalous node in the plurality of nodes. In some embodiments, the method further includes assigning a friend node in the plurality of nodes to assist the anomalous node in implementing a functionality of the anomalous node.

What is claimed is:

1. A method comprising:
collecting characteristic data for each node of a plurality of nodes in a mesh network, wherein each of the plurality of nodes is capable of communicating with all of the plurality of nodes;
performing pattern recognition on the collected characteristic data;
generating a wake-up strategy for each of the plurality of nodes based on the pattern recognition;
controlling each of the plurality of nodes based on the wake-up strategy;
collecting updated characteristic data for each node of the plurality of nodes during the controlling of the plurality of nodes based on the wake-up strategy;
performing updated pattern recognition using the updated characteristic data; and
updating the wake-up strategy based on the updated pattern recognition.

2. The method of claim 1, wherein performing pattern recognition comprises identifying a cluster of nodes among the plurality of nodes, wherein each node in the cluster of nodes has similar characteristic data.

3. The method of claim 2, wherein controlling each of the plurality of nodes comprises controlling each of the plurality of nodes in the cluster of nodes in unison.

4. The method of claim 3, wherein controlling each of the plurality of nodes comprises controlling at least one node of the plurality of nodes other than the cluster of nodes independent from the cluster of nodes.

5. The method of claim 1, wherein performing pattern recognition comprises identifying an anomalous node in the plurality of nodes.

6. The method of claim 5, further comprising assigning a friend node in the plurality of nodes to assist the anomalous node in implementing a functionality of the anomalous node.

7. The method of claim 1, wherein generating the wake-up strategy comprises generating the wake-up strategy having different wake-up protocols depending on a time of day.

8. A system configured to execute a process comprising:
collecting characteristic data for each node of a plurality of nodes in a mesh network, wherein each of the plurality of nodes is capable of communicating with all of the plurality of nodes;
performing pattern recognition on the collected characteristic data;
generating a wake-up strategy for each of the plurality of nodes based on the pattern recognition;
controlling each of the plurality of nodes based on the wake-up strategy;
collecting updated characteristic data for each node of the plurality of nodes during the controlling of the plurality of nodes based on the wake-up strategy;
performing updated pattern recognition using the updated characteristic data; and
updating the wake-up strategy based on the updated pattern recognition.

9. The system of claim 8, wherein performing pattern recognition comprises identifying a cluster of nodes among the plurality of nodes, wherein each node in the cluster of nodes has similar characteristic data.

10. The system of claim 9, wherein controlling each of the plurality of nodes comprises controlling each of the plurality of nodes in the cluster of nodes in unison.

11. The system of claim 10, wherein controlling each of the plurality of nodes comprises controlling at least one node of the plurality of nodes other than the cluster of nodes independent from the cluster of nodes.

12. The system of claim 8, wherein performing pattern recognition comprises identifying an anomalous node in the plurality of nodes.

13. The system of claim 12, wherein the process further comprises assigning a friend node in the plurality of nodes to assist the anomalous node in implementing a functionality of the anomalous node.

14. The system of claim 8, wherein generating the wake-up strategy comprises generating the wake-up strategy having different wake-up protocols depending on a time of day.

15. A non-transitory computer readable medium configured to cause a system to execute a method comprising:
collecting characteristic data for each node of a plurality of nodes in a mesh network, wherein each of the plurality of nodes is capable of communicating with all of the plurality of nodes;
performing pattern recognition on the collected characteristic data;
generating a wake-up strategy for each of the plurality of nodes based on the pattern recognition;
controlling each of the plurality of nodes based on the wake-up strategy;
collecting updated characteristic data for each node of the plurality of nodes during the controlling of the plurality of nodes based on the wake-up strategy;
performing updated pattern recognition using the updated characteristic data; and
updating the wake-up strategy based on the updated pattern recognition.

16. The non-transitory computer readable medium of claim 15, wherein performing pattern recognition comprises identifying a cluster of nodes among the plurality of nodes, wherein each node in the cluster of nodes has similar characteristic data.

17. The non-transitory computer readable medium of claim 16, wherein controlling each of the plurality of nodes comprises controlling each of the plurality of nodes in the cluster of nodes in unison.

18. The non-transitory computer readable medium of claim 17, wherein controlling each of the plurality of nodes comprises controlling at least one node of the plurality of nodes other than the cluster of nodes independent from the cluster of nodes.

19. The non-transitory computer readable medium of claim 15, wherein performing pattern recognition comprises identifying an anomalous node in the plurality of nodes.

20. The non-transitory computer readable medium of claim 19, wherein the method further comprises assigning a friend node in the plurality of nodes to assist the anomalous node in implementing a functionality of the anomalous node.
